(19) United States
(12) Patent Application Publication
(10) Pub. No.: US 2002/0032967 A1
(43) Pub. Date: Mar. 21, 2002

(54) CABBAGE CUTTER

(76) Inventor: BILLIE JEAN LONGSTRETH, FAIRBORN, OH (US)

Correspondence Address: BILLIE JEAN LONGSTRETH, 406 RISING HILL DRIVE, FAIRBORN, OH, 45324

(21) Appl. No.: 09/025,896

(22) Filed: Feb. 18, 1998

(51) Int. Cl. B26B 27/00

(52) U.S. Cl. 30/316; 30/295; 30/151

(57) ABSTRACT

A cabbage cutter consisting of a round metal cylinder with a solid top and an open bottom. The solid top of the cutter is covered with a permanently secured cap that extends slightly over onto the sides of the cylinder that acts as a hand grip and also offers cushion to the hand during its use. The open bottom of the cylinder is a sharp, knife-like cutting edge that can be sharpened if it should become dulled from use. A safety cover that fits over the sharp, knife-like cutting edge that acts as a protective shield when the cabbage cutter is not in use or stored.

### BACKGROUND OF THE INVENTION

This invention relates to a domestic hand utensil used in a kitchen to cut up cabbage. Anybody experienced in cutting up vegetables will agree that cabbage is the most difficult vegetable to cut up. Prior devices, including those that are sold on the market today, have disadvantages. The electrical ones will jam and have to be cleaned out several times during the process of cutting up one head of cabbage, and the designs of the non-electrical ones lack the sturdiness to withstand the heavier chopping that is required for cutting up cabbage. This sturdy cabbage cutter is designed to cut up cabbage better and do it easier than any vegetable cutter, slicer, or chopper product on the market today.

For several years, I have used tin snips to cut off the smooth edge of an empty tin vegetable can and used the sharp edge of the can to cut up my cabbage and have found that it works better than any commercially sold product presently available, and that covers many products. My cabbage cutter invention was developed from this procedure, but it is much sturdier than the old tin can.

### BRIEF SUMMARY OF THE INVENTION

The cabbage cutter consists of a round metal cylinder with a solid top and an open bottom with a sharp, knife-like cutting edge that can be sharpened if it should become dulled from use (just like a regular knife), a permanently secured cap spreads over the solid top of the cylinder and extends slightly over onto the sides to act as a hand grip and will also offer some cushion for the hand when the cabbage cutter is in use, and a safety cover that fits over the sharp, knife-like cutting edge that acts as a protective shield when the cabbage cutter is not in use or is stored.

### BRIEF DESCRIPTION OF THE SEVERAL VIEWS OF THE DRAWING

FIG. 1 is a perspective view of the round metal cylinder with a solid top and an open bottom that has a sharp, knife-like cutting edge.

FIG. 2 is a view of the cap that covers the cylinder's solid top that extends slightly over onto the sides all the way around the cylinder. This cap is permanently secured to the cylinder's solid top.

FIG. 3 is a view of the safety cover that fits over the open, sharp, knife-like cutting edge located at the bottom of the cylinder. This cover acts as a protective shield from the cutting edge when the product is not in use or stored away.

FIG. 4 is a view of the three items merged together to produce the cabbage cutter as a whole product.

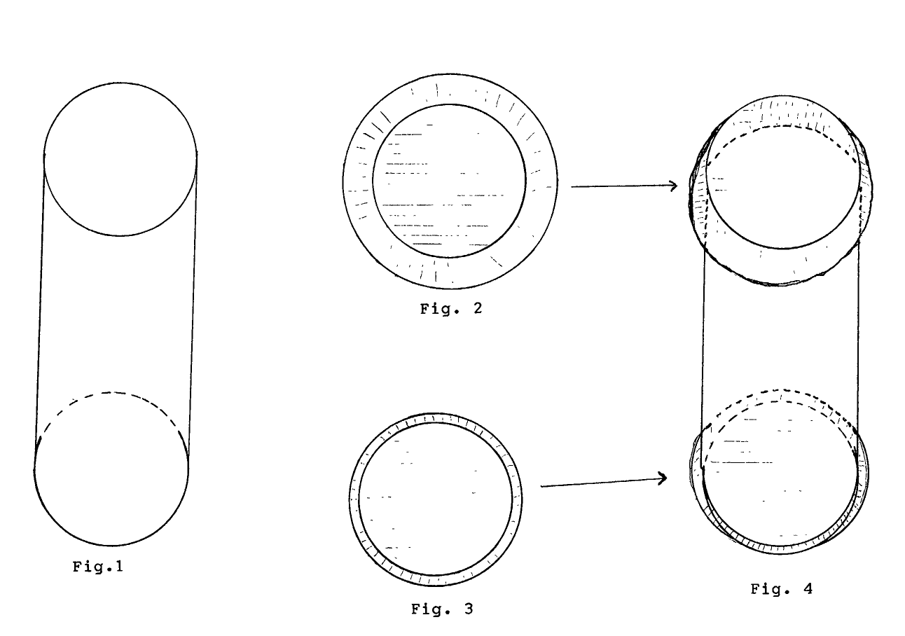

### DETAILED DESCRIPTION OF THE INVENTION

The cabbage cutter is comprised of a round metal cylinder. The top of the cylinder is solid and the bottom of the cylinder is open and has a sharp, knife-like cutting edge that can be sharpened, like a regular knife, if it should become dull from use.

The cylinder has a permanently secured cap, constructed of either rubber or plastic, that covers its solid top and the cap extends slightly over onto its sides all the way around. The cap acts as a hand grip and also offers some comfort and support to the hand during use.

The cabbage cutter has a safety cover, constructed of either metal or plastic, that fits over the sharp, knife-like cutting edge that acts as a protective shield when the product is not in use or when stored.

While there has been shown and described a preferred embodiment of the cabbage cutter, it is understood that changes in structure, material, sizes and shapes can be made without departing from the invention. The invention is defined in the following claims.

I claim:

1. This cabbage cutter, a product used to cut cabbage, consists of one metal cylinder, a permanently secured cap that covers the solid top of the cylinder and extends slightly over onto its sides all the way around, and one safety cover to fit over the sharp, knife-like cutting edge that serves as a protective shield whenever the cabbage cutter is not in use or is stored.
